(19) United States
(12) Patent Application Publication
(10) Pub. No.: US 2009/0221417 A1
(43) Pub. Date: Sep. 3, 2009

(54) Catalyst slurry recycle

(76) Inventors: Alex Magdics, Wickliffe, OH (US); Anna Michalski, Cleveland, OH (US)

Correspondence Address: HAHN LOESER & PARKS, LLP, One GOJO Plaza, Suite 300, AKRON, OH, 44311-1076, US

(21) Appl. No.: 12/156,919

(22) Filed: Jun. 5, 2008

Related U.S. Application Data
(60) Provisional application No. 60/933,348, filed on Jun. 5, 2007.

(51) Int. Cl. B01J 38/64

(52) U.S. Cl. 502/25

(57) ABSTRACT

A process is provided for recycling a catalyst slurry comprising an organic material and a solid catalyst having a metal component disposed on a support. The process comprises contacting the catalyst slurry with an inorganic acid, reacting the inorganic acid with the metal component to form an aqueous metal salt solution phase, and an organic material phase, and separating the support from at least one of the organic material phase and the aqueous metal salt solution phase.

### CROSS-REFERENCE TO RELATED APPLICATIONS

This application claims priority from U.S. Provisional Patent Application No. 60/933,348, filed on Jun. 5, 2007, which is hereby incorporated by reference herein.

### FIELD OF THE INVENTION

The present invention relates generally to a process for recycling a catalyst slurry.

### BACKGROUND OF THE INVENTION

Catalysts have been widely used in the refining and chemical processing industries for many years. Catalysts desirably have the function of increasing the rate of a reaction without being consumed by the reaction. The hydrogenation of organic compounds with the aid of a catalyst is a reaction of great industrial importance. Hydrogenation is a chemical reaction in which hydrogen is added to unsaturated fatty acid double bonds with the aid of a catalyst, and is often used in the production of edible fats from liquid oils. For example, soybean oil contains unsaturated fatty acids such as linolenic acid, linoleic acid, and oleic acid that are capable of being hydrogenated.

Hydrogenation has two primary effects. First, reducing the unsaturated fatty acid content increases the oxidative stability of the oil. Second, the fatty acid modifications increase the melting point, resulting in a semi-liquid or solid fat at room temperature.

There are many variables that affect the hydrogenation reaction and that, in turn, alter the composition of the final product. Operating conditions including pressure, temperature, catalyst type and concentration, agitation, and reactor design are among the more important parameters that can be controlled. Selective hydrogenation conditions can be used to hydrogenate the more unsaturated fatty acids in preference over the less unsaturated ones. Very light, or brush, hydrogenation is often employed to increase stability of liquid oils. Further hydrogenation may be used to convert liquid oil to a solid fat. The degree of hydrogenation depends on the desired performance and melting characteristics of the particular end product. Liquid shortenings used in the manufacture of baking products, solid fats and shortenings used for commercial frying and roasting operations, and base stocks for margarine manufacture are among the myriad of possible oil and fat products achieved through hydrogenation.

During hydrogenation, catalyst performance deteriorates with on-stream time for various reasons. This effectively destroys the usefulness of the catalyst, as it can no longer increase the rate of reaction. The catalyst can then be considered ‘spent,’ and a portion of or all of the spent catalyst can be removed from a reactor vessel. The spent catalyst removed from the reactor vessel can undergo a regeneration process if the activity of the removed spent catalyst can be at least partially restored. However, in some cases the loss of the catalyst activity is irreversible.

An important aspect of the economics of a process is the efficient utilization of the metals used in the catalyst. The initial costs of the metals employed in such catalysts are a large capital expenditure. Accordingly, once the catalyst has become unacceptable for use in the process, it would be desirable to recover the metals from the spent catalyst for reuse; for example, to prepare new batches of fresh catalyst. In such cases, it is also preferable to recover substantially all of any organic material from the solid catalyst. However, recycling processes generally utilize a calcination step to remove such organic materials. Therefore, valuable organic materials are lost, resulting in decreased overall profits. In addition, the metals are oxidized, thereby making it difficult and expensive to recover the metal component.

Some attempts have been made to remove the organic material from the solid catalyst without destroying the organic material. However, such attempts typically utilize large amounts of organic solvents and complex processes. Further, such attempts often result in dangerous conditions, as the exposed metal presents an explosion or fire hazard.

Due to the lack of satisfactory recycling processes, the spent catalyst is often landfilled, which is expensive and raises environmental concerns. Therefore, a need exists in the art for efficient methods and systems for removal of organic materials from solid catalysts, wherein substantially all of the organic materials are recovered. Such a process would recover the organic materials and minimize the presence of such materials in any waste for environmental conservation reasons. Further, a need exists for the recovery of the metal and the support of the solid catalyst.

Additional information will be set forth in the description which follows and in part will be obvious from the description or may be learned by practice of the invention.

### SUMMARY OF THE INVENTION

A process is provided for recycling a catalyst slurry comprising an organic material and a solid catalyst having a metal component disposed on a support. The process comprises contacting the catalyst slurry with an inorganic acid, reacting the inorganic acid with the metal component to form an aqueous metal salt solution phase, and an organic material phase, and separating the support from at least one of the organic material phase and the aqueous metal salt solution phase.

In another aspect a process is provided for recycling a catalyst slurry comprising an organic material and a solid catalyst having a metal component disposed on a support. The process comprises passing the catalyst slurry through a separation unit to separate the organic material and the solid catalyst, wherein the solid catalyst includes residual organic material, contacting the catalyst slurry with an inorganic acid, reacting the inorganic acid with the metal component to form an aqueous metal salt solution phase and a residual organic material phase, and separating the support from at least one of the organic material phase and the aqueous metal salt solution phase.

Further features or embodiments of the invention will be described or will become apparent in the course of the following detailed description.

### BRIEF DESCRIPTION OF THE DRAWINGS

The operation of the invention may be better understood by reference to the following detailed description taken in connection with the following illustrations, wherein:

FIG. 1 illustrates a flow diagram of a preferred embodiment of a process for recycling a catalyst slurry;

FIG. 2 illustrates a flow diagram of another preferred embodiment of a process for recycling a catalyst slurry having a separation unit;

FIG. 3 illustrates a flow diagram of another preferred embodiment of a process for recycling a catalyst slurry having a separation unit; and

FIG. 4 illustrates a flow diagram of another preferred embodiment of a process for recycling a catalyst slurry having a countercurrent arrangement.

### DETAILED DESCRIPTION OF THE PREFERRED EMBODIMENTS

While the present invention is described with reference to the embodiments described herein, it should be clear that the present invention should not be limited to such embodiments. Therefore, the description of the embodiments herein is illustrative of the present invention and should not limit the scope of the invention as claimed.

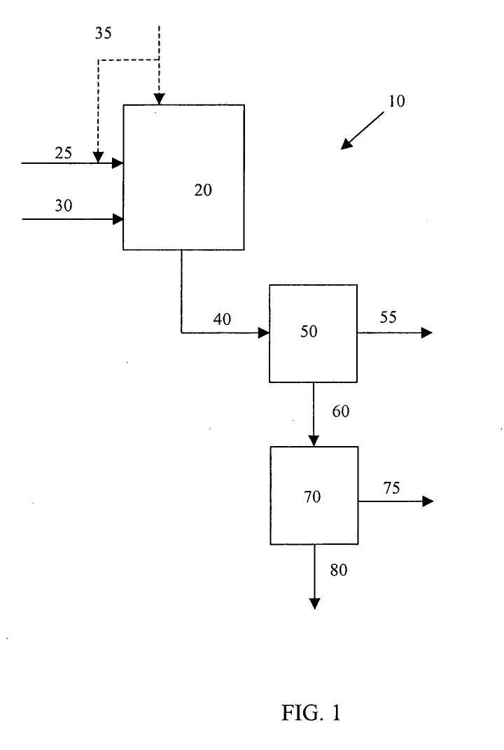

Generally, referring to FIG. 1, a process 10 is provided for recycling a catalyst slurry. The catalyst slurry comprises an organic material and a solid catalyst. The solid catalyst comprises a metal component and a solid support. The catalyst slurry is contacted with an inorganic acid to react with the metal component to form an aqueous metal salt solution (hereinafter referred to as “aqueous solution”). The solid support, organic material, and aqueous solution are separated as salable products without destroying the organic material or dissolving the solid support.

The solid catalyst may have one or more metal components (hereinafter referred to as “metal” or “metals”) on the solid support for catalyzing reactions. Illustrative examples of metals used for catalyzed reactions include, but are not limited to, nickel, cobalt, platinum, copper, copper chromite, silver, ruthenium, rhenium, boron, palladium, and their oxides, and mixtures thereof.

The solid catalyst may also include other metals and/or metal oxides that promote the catalytic activity. Such metals and metal oxides are also known as promoters. Illustrative examples include, but are not limited to, platinum, palladium, rhenium, and ruthenium. Illustrative examples of solid supports include, but are not limited to, diatomaceous earth, alumina, silica, titania, zirconia, and mixtures thereof.

It is to be understood, however, that other metals, promoters, and solid supports may be used. In addition, while some embodiments referred to herein describe hydrogenation catalysts containing nickel as the metal and diatomaceous earth as the solid support, the process 10 may be used with any suitable catalyzed synthesis reaction having a catalyst slurry comprising an organic material and a solid catalyst.

As used herein, the term “catalyst slurry” refers generally to a mixture of solid catalyst and organic material. The solid catalyst content in the catalyst slurry may comprise up to about 99 percent by weight (wt %) of the total weight of the catalyst slurry. In an illustrative example, the solid catalyst content in the catalyst slurry may be from about 5-80 wt % of the total weight of the catalyst slurry; and in another non-limiting example, from about 30-50 wt % of the total weight of the catalyst slurry.

In a non-limiting example, the solid catalyst may comprise a metal content up to about 50 wt % of the total weight of the solid catalyst. In an illustrative example, the solid catalyst may comprise a metal content from about 1-20 wt % of the total weight of the solid catalyst. In yet another example, the solid catalyst may comprise a metal content from about 3-10 wt % of the total weight of the solid catalyst. It is to be understood that the solid catalyst may be a spent catalyst, partially spent catalyst, or a fresh catalyst.

As used herein, an “organic material” refers to any organic solid, liquid, or a combination thereof, in which the solid catalyst is dispersed or otherwise mixed. In addition, the organic material may be an organic layer or film on and/or inside the solid catalyst structure. It is to be understood that, when the organic material comprises both an organic liquid and an organic layer, the composition of the organic liquid and the organic layer may be the same or different. For example, the organic layer on and/or inside the solid catalyst may be solid organic compounds that coat the catalyst surface or may be molten organic compounds that are adsorbed and/or embedded inside the solid catalyst. Illustrative examples of organic materials include, but are not be limited to, oils, fats, and waxes.

As used herein, the term “oil” may include, but is not limited to, any synthetic, plant, or animal oils, and mixtures thereof. Illustrative examples include soybean, canola, palm cottonseed, olive, coconut, peanut, lard, beef tallow, butterfat, sunflower, corn, palm kernel, and safflower. The oils may contain a variety of unsaturated and/or saturated fatty acids and glycerides. Illustrative examples of unsaturated fatty acids include caproleic, lauroleic, myristoleic, palmitoleic, oleic, elaidic, vaccenic, linoleic, linolenic, gadoleic, arachidonic, and erucic. Illustrative examples of saturated fatty acids include butyric, caproic, caprylic, capric, lauric, myristic, palmitic, margaric, stearic, arachidic, and behenic.

As used herein, the term “fat” may include, but is not limited to, a hydrocarbon or a mixture of hydrocarbons comprising a number of carbon atoms up to about 24 (i.e., C₂₄ hydrocarbons). It is understood that the hydrocarbon or hydrocarbons may be unsaturated, partially saturated, or saturated, and mixtures thereof. Fat in the catalyst slurry may be in the form of a liquid, a molten liquid, semi-solid, or solid. The fat composition may differ, whether it is a liquid or a “solidified’ layer or film on the solid structures. The fat may have a melting point of up to about 200° C. and in some embodiments from about 30° C. to about 90° C. However, it is understood that fats with higher and lower melting points may used in the present process 10.

As used herein, a “separation unit” refers generally to any solid-liquid separation unit capable of filtration, decantation, sedimentation, centrifugation, magnetic separation, or any combination thereof. For example, a separation unit may include, but is not limited to, a settler, a hydrocyclone, a magnetic separation unit, a centrifuge, a filter, or any combination of two or more thereof. Non-limiting examples of filters include rotary filters, cross-flow filters, cake filters, belt filters, leaf filters, and the like. Generally, such filters are aided by a filter substrate or media through which the separation takes place. For example, the solid catalyst or solid support is retained on the filter media, while the organic material (or any liquid) flows through and exits the separation unit as filtrate.

As used herein, a “filter cake,” “retentate stream,” or “retentate” refers generally to a solids-enriched stream that is generated as a result of solid-liquid separation. It is understood that solid-separation systems are not limited to filtration units, as any type of separation technique that can provide an increased solid content to the “retentate stream” may be used.

As used herein, “inorganic acid” may refer generally to any inorganic acid. Illustrative examples of inorganic acids include, but are not limited to, hydrochloric acid, nitric acid, sulfuric acid, phosphoric acid, and mixtures thereof.

Referring to an embodiment as shown in FIG. 1, the catalyst slurry recovery process 10 may comprise a leaching unit 20. It is to be understood that the leaching unit 20 may be capable of operating under a variety of temperatures, pressures, and inert atmospheres. The catalyst slurry 25 and an inorganic acid 30 may be fed into the leaching unit 20 and mixed with any type of suitable mixers. Illustrative examples of mixing include, but are not limited to, static mixers, gas agitation, pump recirculation, turbines, and impellers.

The organic material in the catalyst slurry 25 may comprise an organic solid, liquid, or combination thereof. If the organic material includes a solid component, such as fat or wax, the catalyst slurry 25 may be maintained at a temperature sufficient to keep its solid component in a molten (or fluid) state.

It is to be understood that the catalyst slurry 25 may be provided directly “as is” from a reaction vessel to the leaching unit 20. Alternatively, the catalyst slurry 25 may be diluted, for example, with a second feedstream 35. The second feedstream 35 may be added to improve the catalyst slurry flowability (such as by reducing the viscosity of the catalyst slurry 25). Additionally or alternatively, second feedstream 35 may be added to the catalyst slurry 25 to improve the transportability (pumpability) of the catalyst slurry 25. The second feed stream 35 may include, but is not limited to, solvents, water, or inorganic acids. The solvents may be any hydrocarbon liquid, including, but not limited to naptha, kerosene, diesel, alcohol, ketones, acetone, esters, or mixtures thereof. In a non-limiting example, the amount (e.g., volume) of added solvent can range from about 5% to about 200% the volume of the organic material in the catalyst slurry. In another illustrative example, the amount of added solvent may range from about 50% to about 150% the volume of the organic material in the catalyst slurry.

In an illustrative example, the catalyst slurry may not be introduced directly from a reactor to the leaching unit 20. In some instances, the catalyst slurry must be stored, for example, in drums prior to recycling. Accordingly, the catalyst slurry may cool to form a solid or semi-solid mass. In such cases, the solidified catalyst slurry may be reheated to form a molten liquid and/or mixed with a sufficient amount of solvent to form a processable slurry.

In another illustrative example, such a solidified catalyst slurry may be pretreated with an inorganic acid. Due to the hydrophobic properties of, for example, any fats (or other solid component) in the solidified catalyst slurry, the organic material will not dissociate in water alone. Addition of the inorganic acid transforms the solidified catalyst slurry into a processable or pumpable state. A mixer may be provided to mix the inorganic acid with the solidified catalyst slurry. It is to be understood that the mixture may also be heated. In a non-limiting example, the pretreatment step may be performed in leaching unit 20.

In an illustrative example, about 100 lbs. of catalyst slurry, about 6 to about 18 lbs. of sulfuric acid (93 wt % sulfuric acid) and about 25 to about 45 lbs. of water may be mixed to improve the processability of the catalyst slurry. In another illustrative example, about 100 lbs. of catalyst slurry, about 12 lbs. of sulfuric acid (93 wt % sulfuric acid), and about 37 lbs. of water may be mixed.

Leaching unit 20 may be any vessel or unit capable of contacting (or otherwise mixing) the catalyst slurry 25 with the inorganic acid 30. The catalyst slurry 25 may be heated prior to and/or during contact with the inorganic acid 30 to a temperature of about 40° C.-100° C. In another non-limiting example, the temperature may be from about 50° C.-60° C. It is to be understood, however, that one of ordinary skill in the art will appreciate that higher and lower temperatures may be used while contacting the catalyst slurry with the inorganic acid. For example, the temperature in leaching unit 20 may be greater than the melting point of any solid organic material in the catalyst slurry. Further, it is to be understood that the reaction rate of the metal and the inorganic acid depends on the temperature of the reactor, the concentration of the inorganic acid, and the concentration of the metal. Therefore, the temperature and the inorganic acid concentration can be adjusted to provide for a residence time of about 30 minutes to about 24 hours, and preferably from about 3 hours to about 6 hours.

Still referring to FIG. 1, the catalyst slurry 25 and inorganic acid 30 are fed to leaching unit 20 and mixed. The amount of inorganic acid 30 fed to the leaching unit 20 may be based on about a 1:1 molar ratio with the metal contained in the catalyst slurry 25 that is fed to the leaching unit 20. The metal reacts with the inorganic acid without exposing the metal to the air. Such a process is advantageous for a number of reasons including, but not limited to, preventing the metal from being exposed so that it does not present a fire or explosion hazard.

It is to be understood that excess inorganic acid may be provided. For example, the molar ratio of inorganic acid to metal may be from about 1:1 to about 2:1. In another example, the molar ratio of inorganic acid to metal may be about 1:1 to about 1.5:1, and in yet another example, the molar ratio of inorganic acid to metal may be about 1:1 to about 1.1:1. Further, it is to be understood that water may be added at a concentration sufficient to keep the metal salt dissolved in the aqueous solution.

In an illustrative example, the metal content in the aqueous solution may comprise up to about 13 wt % of the total weight of the aqueous solution. In a non-limiting example, the metal content in the aqueous solution may be about 1-12 wt % of the total weight of the aqueous solution. In another example, the metal content in the aqueous solution may be about 6-11 wt % of the total weight of the aqueous solution. Preferably, the metal content in the aqueous solution is about 8-10 wt % of the total weight of the aqueous solution. It is to be understood that the metal content in the aqueous solution may be adjusted, for example, by increasing or decreasing the water concentration. Further, longer and shorter reaction times may be achieved by varying the temperature, inorganic acid concentration, and the number of leaching unit stages.

In a non-limiting example, the catalyst slurry 25 includes a fatty acid as the organic material, and a solid catalyst including nickel (metal) disposed on a diatomaceous earth solid support. Further, the inorganic acid is sulfuric acid. As the catalyst slurry 25 and the inorganic acid 30 are mixed in the leaching unit 20, the sulfuric acid reacts with the nickel as set forth below:

Ni+H₂SO₄→NiSO₄+H₂

The organic material forms an organic phase and the aqueous solution forms an aqueous phase, similar to oil and water. The solid support remains in the aqueous phase, the organic phase, or along the interface between the organic phase and aqueous phase, depending on the density of the solid support.

After leaching, the components of the leach slurry 40 (the organic material, aqueous solution, and the solid support) may be separated as salable products. For example, the leach slurry 40 may be sent to a separation unit 50 to remove the solid support 55 as a salable product. The filtrate 60 (including the organic material and aqueous solution) may be sent to a phase separator 70 where the organic material 75 and aqueous solution 80 may be collected as salable products. The phase separator 70 may be any tank or vessel capable of receiving the filtrate 60 so that the aqueous phase and organic phase may be separated. For example, the aqueous phase and the organic phase may be decanted. In another illustrative example, one of the phases may be drained from phase separator 70, for example by opening a valve at the bottom of the phase separator 70, similar to a separatory funnel. In another illustrative example, either of the phases may be pumped out of the phase separator 70. It is also to be understood that the organic material and the aqueous solution may be separated before removing the solid support. The solid support may then be separated from either the organic phase or aqueous phase, depending on the density of the support.

If the organic material 75 also contains an organic solvent, it is to be understood that the organic material 75 can be sent for subsequent fractionation or refining and upgrading; for example, for generating salable products from the organic material and the organic solvent. In a non-limiting example, if the organic material 75 and solvent form two separate phases, they may be separated using the same methods used to separate the organic material from the aqueous solution.

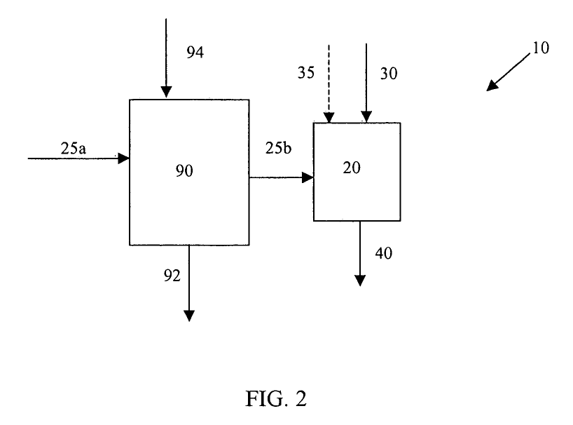

As shown in FIG. 2, a separation unit 90 may be provided prior to the leaching unit 20. The separation unit 90 may comprise an inlet through which the catalyst slurry 25a is fed, a retentate outlet through which a retentate 25b (containing solid catalyst and residual organic material) exits, and a filtrate outlet through which a filtrate 92 (containing organic material) exits. The filtrate 92 may be collected as a salable product.

For example, the catalyst slurry 25a is fed to the separation unit 90. The catalyst slurry 25a may be drawn from a reaction vessel, such as a hydrogenation reactor (not shown). If the organic material includes a solid component, the catalyst slurry 25a may be maintained at a temperature sufficient to maintain its solid component in a molten state.

A washing medium 94 may be added to the separation unit 90 to improve separation. Washing medium 94 may include the same components as the second feedstream 35. It is to be understood that the solid catalyst may contain a residual amount of organic material to prevent exposure of the metal to air.

The retentate 25b (including the solid catalyst and residual organic material) is fed to the leaching unit 20, and mixed with the inorganic acid 30 as described above. In an illustrative example, the content of residual organic material in retentate 25b may be less than about 30 wt % of the total weight of the retentate 25b. In another non-limiting example, the content of residual organic material in retentate 25b may be less than about 20 wt % of the total weight of the retentate 25b.

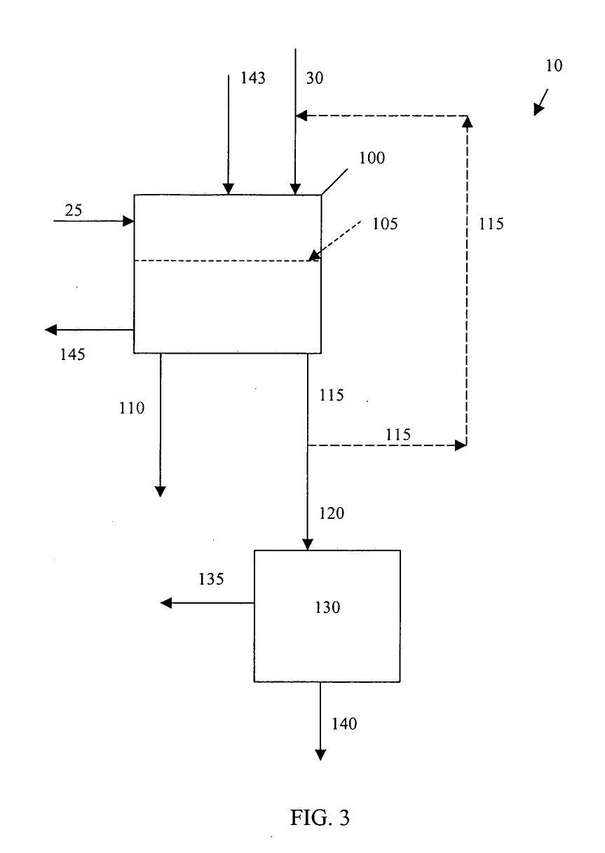

In another embodiment, as shown in FIG. 3, the process 10 may comprise a separation unit 100. The separation unit 100 may comprise one or more filter substrates (or media) 105 upon which the solid catalyst and residual organic material is retained. For example, the catalyst slurry 25 may be fed to the separation unit 100 so that the organic material passes through the substrate 105 and exits the separation unit 100 as filtrate 110 while the solid catalyst is retained on the substrate 105. Accordingly, organic material (filtrate 110) may be recovered as a salable product.

The inorganic acid 30 may be fed to the separation unit 100 to contact the solid catalyst retained on the media 105. The inorganic acid reacts with the metal and the aqueous solution exits the separation unit 100 as filtrate 115. It is understood that in some embodiments, the aqueous solution (filtrate 115) may be circulated until substantially all of the metal is leached from the solid support. Such a configuration increases the residence time for the leaching to occur and minimizes the need for excess inorganic acid. If the aqueous solution 115 is not circulated (or is finished circulating), it may continue along stream 120 to be recovered as a salable product. It is to be understood, however, that the residual organic material may be present in the aqueous solution 120. As such, the aqueous solution 120 may be transferred to a phase separation unit 130 to separate the organic material 135 and aqueous solution 140 as described above.

The solid support remaining on the filter media 105 may be washed with stream 143, such as water, acid, and mixtures thereof. The solid support 145 may be removed from the filter media 105 as a salable product.

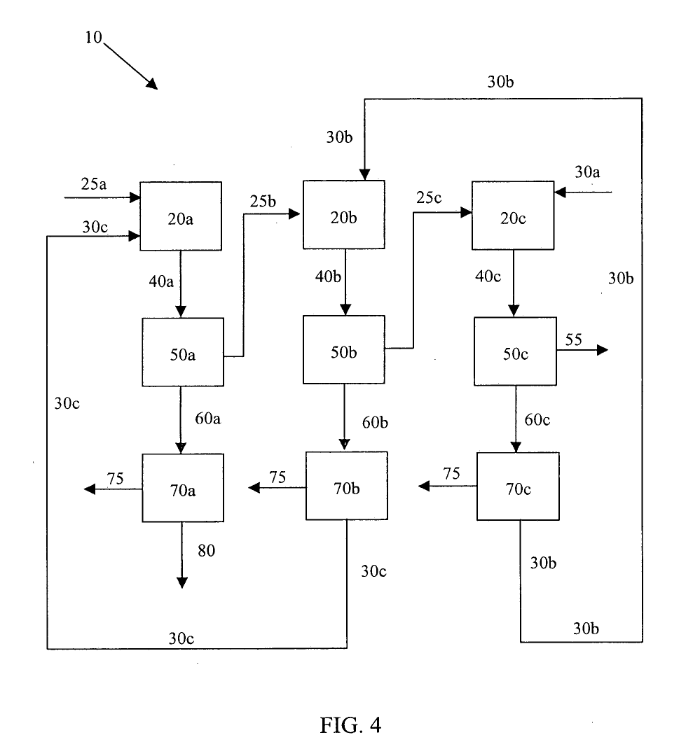

In an embodiment, as shown in FIG. 4, a series of leaching units 20a, 20b, 20c may be provided. The catalyst slurry 25a may be introduced to the leaching unit 20a, and the inorganic acid 30a may be introduced to the leaching unit 20c in a counterflow (or countercurrent) arrangement. The catalyst slurry 25a is contacted with the aqueous solution 30c. The resulting leach slurry 40a contains aqueous solution, solid catalyst, and organic material. The leach slurry 40a may be sent to separation unit 50a and the filtrate 60a may be sent to a phase separator 70a to separate the aqueous solution 80 and the organic material 75 as salable products.

The retentate 25b (containing residual organic material and solid catalyst with a lower metal content than the solid catalyst of the catalyst slurry 25a) is fed to the leaching unit 20b and mixed with aqueous solution 30b. The leach slurry 40b containing an aqueous solution, solid catalyst, and residual organic material. The leach slurry 40b may be sent to separation unit 50b and the filtrate 60b may be sent to a phase separator 70b to separate the organic material 75 as a salable product. The aqueous solution 30c (containing a metal salt solution and some inorganic acid), is fed to the leaching unit 20a as described above.

The retentate 25c (containing residual organic material and solid catalyst with a lower metal content than the solid catalyst of the retentate 25b) is fed to leaching unit 20c. It is in leaching unit 20c that the inorganic acid 30a, having the highest acid concentration (compared to streams 30b and 30c), is mixed with the retentate 25c to facilitate leaching of substantially all of the metal from the solid support. The resulting leach slurry 40c contains aqueous solution, solid support, and residual organic material. The leach slurry 40c may be sent to separation unit 50c and the filtrate 60c may be sent to a phase separator 70c to separate the organic material 75 as a salable product. The aqueous solution 30b (containing a metal salt solution and inorganic acid) is fed to the leaching unit 20b. The retentate 55 contains the clean solid support as a salable product.

Accordingly, the counterflow process allows for retentate 25c (having the solid catalyst with the lowest metal concentration) to be contacted with the highest concentration of inorganic acid (30a) in leaching unit 20c. Likewise, aqueous solution 30c (with the lowest concentration of inorganic acid) is contacted with the solid catalyst of catalyst slurry 25a with the highest concentration of metal. Therefore, substantially all of the metal may be recovered without using substantially more than the required molar amount of inorganic acid with respect to the metal content of the solid catalyst in the catalyst slurry 25a.

It is to be understood that the process 10 described herein may be operated in a continuous, batch, or semi-batch operation. It is to be understood that if more than one metal is present and each metal is dissolved into the aqueous solution, one of ordinary skill in the art will appreciate that the metals may be separated from the aqueous solution by a variety of methods known in the art. It is also to be understood that the aqueous solution may contain some impurities and, in some examples, small quantities of dissolved support. However, one of ordinary skill in the art will appreciate that a variety of methods may be used to remove such impurities. Further, it is to be understood some promoters and/or metals (when more than one metal is present) may not be leached from the support. In such situations, the support and any remaining metal or promoter may be further processed to recover such metals and promoters. In such an example, the present process 10 provides the benefit of upgrading the content of any remaining metal or promoter for further processing, by removing substantially all of the organic material and at least one metal from the solid support.

Therefore, it is understood that various configurations for the process 10 are possible to be or for recovering at least three substantially pure products (organic material, aqueous solution, and solid support) from the catalyst slurry.

The following examples were prepared in accordance with the invention and are intended to illustrate the invention without, however, limiting it.

### Example 1

A 219 g sample of a catalyst slurry comprising a solid hydrogenation catalyst and fat was provided. The solid catalyst in the sample appeared dark due to the presence of nickel on the catalyst support. Further, the fat caused the solid catalyst to agglomerate rather than flow freely. The solid hydrogenation catalyst contained an unknown quantity of nickel on a diatomaceous earth support. The melting point of the fat was less than 50° C.

The sample was mixed with about 440 g of water and about 47 g of 93% (by weight) sulfuric acid and heated at 50° C. for 5 hours. The fat melted and the sulfuric acid reacted with the nickel metal to form an aqueous nickel sulfate solution. The fat formed an organic phase separate from the aqueous nickel sulfate solution phase. The diatomaceous earth support was separated with a filter and the organic phase and aqueous phases were separated with a separation funnel. The diatomaceous earth support appeared light and free flowing indicating that substantially all of the nickel and fat have been removed. The aqueous phase contained about 3% nickel by weight of the aqueous solution. It is understood that a higher nickel weight percent could have been obtained by decreasing the amount of water added. Other trace metals (Al, Ca, Fe, Mg, Na) were present in the aqueous solution, but only in negligible amounts (<1000 ppm).

### Example II

A sample of a catalyst slurry comprising a solid hydrogenation catalyst and fat was provided. The solid hydrogenation catalyst contained nickel on a diatomaceous earth support. The sample was contacted with sulfuric acid in countercurrent leaching units (batch basis) as described above with respect to FIG. 4. The sulfuric acid 30a was provided on a 1.1:1 molar ratio with the nickel contained on the solid catalyst of the catalyst slurry 25a. About 40 wt % of the nickel on the solid catalyst of the catalyst slurry 25a was removed in leaching unit 20a. About 65 wt % of the nickel on the solid catalyst of the retentate 25b was removed in leaching unit 20b. About 97 wt % of the nickel on the solid catalyst of the retentate 25c was removed in leaching unit 20c. The aqueous solution 80 (nickel sulfate solution) had a nickel content of about 7.5 wt %.

Although the preferred embodiment of the present invention has been illustrated in the accompanying drawing and described in the foregoing detailed description, it is to be understood that the present invention is not to be limited to just the preferred embodiment disclosed, but that the invention described herein is capable of numerous rearrangements, modifications, and substitutions without departing from the scope of the claims hereafter.

What is claimed is:

1. A process for recycling a catalyst slurry comprising an organic material and a solid catalyst having a metal component disposed on a support, said process comprising:
a) contacting said catalyst slurry with an inorganic acid;
b) reacting said inorganic acid with said metal component to form an aqueous metal salt solution phase, and an organic material phase; and
c) separating said support from at least one of said organic material phase and said aqueous metal salt solution phase.

2. The process of claim 1, wherein the molar ratio of inorganic acid to metal is the range of about 1:1 to about 2:1.

3. The process of claim 2, wherein said inorganic acid is selected from the group consisting of sulfuric acid, hydrochloric acid, nitric acid, phosphoric acid, and mixtures thereof.

4. The process according to claim 1, wherein the solid catalyst comprises about 3.0% to about 10% metal based on weight of solid catalyst.

5. The process according to claim 4, wherein the metal is selected from the group consisting of nickel, cobalt, ruthenium, and combinations thereof.

6. The process according to claim 1, wherein the support is selected from the group consisting of diatomaceous earth, alumina, titania, silica and combinations thereof.

7. The process of claim 1, wherein the aqueous solution comprises about 3.0% to about 10% metal based on weight of aqueous solution.

8. The process according to claim 1, wherein the organic material is selected from the group consisting of fats, oils, fatty acids, and combinations thereof.

9. The process of claim 1, wherein the catalyst slurry comprises about 15% to about 50% solid catalyst based on weight of catalyst slurry.

10. The process of claim 1, wherein said support is separated from said organic material and said aqueous solution by filtration.

11. The process of claim 1, further comprising separating said organic material phase from said aqueous metal salt solution phase by decantation.

12. The process of claim 1, further comprising heating said organic material above the melting point of any solid organic component present in said organic material.

13. A process for recycling a catalyst slurry comprising an organic material and a solid catalyst having a metal component disposed on a support, said process comprising:
a) passing said catalyst slurry through a separation unit to separate said organic material and said solid catalyst, wherein said solid catalyst includes residual organic material;
b) contacting said catalyst slurry with an inorganic acid;
c) reacting said inorganic acid with said metal component to form an aqueous metal salt solution phase, and a residual organic material phase; and
e) separating said support from at least one of said organic material phase and said aqueous metal salt solution phase.

14. The process of claim 13 wherein, said separation unit comprises a filter media for retaining said solid catalyst and said residual organic material during said passing step.

15. The process of claim 14, wherein said contacting step is performed in said separation unit while said solid catalyst and residual organic material is retained on said filter media.

16. The process of claim 13 wherein said residual organic material is less than about 25% by weight of said solid catalyst and said residual organic material.

17. The process of claim 13, wherein said inorganic acid is selected from the group consisting of sulfuric acid, hydrochloric acid, boric acid, nitric acid, phosphoric acid, and mixtures thereof.

18. The process of claim 13, wherein the metal is selected from the group consisting of nickel, cobalt, ruthenium, and combinations thereof.

19. The process of claim 13, the organic material is selected from the group consisting of fats, oils, fatty acids, and combinations thereof.

20. The process of claim 13 further comprising heating said catalyst slurry above the melting point of any solid organic component present in said organic material.
